(19) United States
(12) Patent Application Publication
(10) Pub. No.: US 2005/0060431 A1
(43) Pub. Date: Mar. 17, 2005

(54) System, apparatus, and method for using reduced web service messages

(76) Inventor: Stephen Paul Lewontin, Cambridge, MA (US)

Correspondence Address: Crawford Maunu PLLC, Suite 390, 1270 Northland Drive, St. Paul, MN, 55120, US

(21) Appl. No.: 10/662,059

(22) Filed: Sep. 12, 2003

(51) Int. Cl. G06F 15/16

(52) U.S. Cl. 709/246; 709/230

(57) ABSTRACT

A system, apparatus, and method is described for using reduced Web service messages. A reduced Web service message is formed at a first data processing arrangement based on at least a variant portion of a Web service message, such as a SOAP message. The Web service message contains data targeted for processing by a second data processing arrangement. The reduced message may contain only the variant data, or it may contain additional data representing some or all of the invariant data of the Web service message. The reduced message is sent via a network targeted for the second data processing arrangement. The reduced message may be used to form a reproduction of the Web service message, and the reproduction can be processed by the second data processing arrangement.

### FIELD OF THE INVENTION

This invention relates in general to Web services, and more particularly, to Web service messages.

### BACKGROUND OF THE INVENTION

Lately, the emergence of what are known as “Web services” has been used to extend the World Wide Web's capability by providing access to computational procedures over the Web. Initially, content published on the Web was in the form of static pages that were downloaded to a browser. The browser interpreted the page for display, as well as handling user input to objects such as forms or buttons. Later adaptations to Web servers include providing dynamic content on demand, although this content was still intended for access by Web browsers.

Web services allow information to be accessed in other application domains besides browsers. Web services use some of the same open and extensible protocols and formats that have made Web browsers so useful. As a result, Web services can be powerful tools usable for providing distributed data access in many application domains.

Web services are network-based (particularly Internet-based) applications that perform a specific task and conform to a specific technical format. Web services are represented by a stack of emerging standards that describe a service-oriented, application architecture, collectively providing a distributed computing paradigm having a particular focus on delivering services across the Internet.

Generally, Web services are implemented as self-contained modular applications that can be published in a ready-to-use format, located, and invoked across the World Wide Web. When a Web service is deployed, other applications and Web services can locate and invoke the deployed service. They can perform a variety of functions, ranging from simple requests to complicated business processes.

Web services are typically configured to use standard Web protocols such as Hypertext Transfer Protocol (HTTP), Extensible Markup Language (XML) and Simplified Object Access Protocol (SOAP). HTTP is an application-level protocol commonly used to transport data on the Web. XML is a mechanism to define markup languages. Some markup languages (e.g. XHTML) are used mainly to describe how a document is to be formatted for display. Others, such as SOAP, are used to describe data. SOAP is a markup language for message encapsulation and is typically used to transmit messages that invoke remote procedure calls, return the results from such invocation, or to transmit documents.

The availability of Web services has made the Web a much more powerful tool. Web services can use the same protocols and markup languages as Web browsers, but Web services can be invoked by any program. Hence, web services can be a part of a program carrying out any kind of computation, yet can be accessed and run anywhere due to the ubiquity of the Internet and its associated protocols. Further, the Web service standards can be adapted handle almost any type of data, due to the use of extensible languages such as XML.

The flexibility and extensibility of typical Web services such as SOAP come at a cost, however. The text based, tagged format of XML is quite verbose. Although binary formats can be used for Web services, text representations are preferred for languages such as XML because they easier to read and debug than binary representations. However, text representations take up more space in memory than binary formats, and therefore require more bandwidth to transmit. In addition, the tags and other required fields such as header fields, Universal Resource Identifiers (URIs) increase the data overhead when using these types of Web services, especially on small, simple transactions.

Although the Web network infrastructure is increasingly adding bandwidth capacity, many users are forced to rely on limited bandwidth connections. This is especially true of mobile device users. The physics of wireless data transfer makes it much more difficult to provide high bandwidth at a reasonable cost. As a result, the bandwidth available to mobile devices is not necessarily catching up to the processing power provided in the devices themselves. As a result of bandwidth limitations, users of mobile devices may not be able to efficiently use Web services utilizing protocols such as SOAP.

### SUMMARY OF THE INVENTION

The present disclosure relates to a system, apparatus, and method for using reduced Web services messages. In accordance with one embodiment of the invention, a method involves forming a reduced message at a first network entity based on at least a variant portion of a Web service message. The Web service message includes a data set targeted for processing on a second network entity. The reduced message is sent and targeted for the second network entity via a network. The data set is processed at the second network entity based on the reduced message.

In accordance with another embodiment of the present invention, a messaging system includes a first data processing arrangement coupled to transmit a reduced message based on at least a variant portion of a Web service message. The Web service message defines a set of data targeted for processing on a data processing arrangement. A message processing arrangement is coupled to receive the reduced message and transmit a reproduction of the Web service message based on the reduced message. A second data processing arrangement is coupled to receive the reproduction of the Web service message and process the set of data of the Web service message based on the reproduction of the Web service message.

The Web service messages may include SOAP messages. The reduced message may contain reference data based on an invariant portion of the Web service message. The reference data may include any combination of a binary representation of the invariant portion, and a reference to a data store containing criteria for forming a reproduction of the invariant portion.

### BRIEF DESCRIPTION OF THE DRAWINGS

The invention is described in connection with the embodiments illustrated in the following diagrams.

FIG. 1 illustrates a system environment in which a Web service messaging arrangement according to embodiments of the present invention may be employed;

FIG. 2 illustrates an example reduced Web service message arrangement according to embodiments of the present invention;

FIG. 3 illustrates various reduced message arrangements according to embodiments of the present invention;

FIG. 4 illustrates one arrangement of providing reduced messaging between network entities according to embodiments of the present invention;

FIG. 5 illustrates another arrangement of providing reduced messaging between network entities according to embodiments of the present invention;

FIG. 6 illustrates a flowchart indicating a procedure of implementing reduced messaging according to embodiments of the present invention;

FIG. 7 illustrates a computing arrangement for processing of reduced messages according to embodiments of the present invention; and

FIG. 8 illustrates a mobile terminal for processing of reduced messages according to embodiments of the present invention.

### DETAILED DESCRIPTION OF THE INVENTION

In the following description of the example embodiments, reference is made to the accompanying drawings which form a part hereof, and in which is shown by way of illustration various example embodiments in which the invention may be practiced. It is to be understood that other embodiments may be utilized, as structural and operational changes may be made without departing from the scope of the present invention.

Generally, the present disclosure is directed to a system, apparatus, and method that reduces the size of Web service messages communicated between network entities. The Web service messages can be partitioned into variant and invariant data. The invariant data does not change for all invocations of the same interface, so the invariant data may be redundant when communicating many Web service transactions. The invariant data can be removed, and a reduced message formed from the variant data. The reduced message can then be sent over a communications link.

Predetermined criteria can be used for forming a reduced message from the variant data of the Web service message. The reduced message is directed to the destination via the network, and the original message can be reproduced from the reduced message using the predetermined criteria. Using reduced messages can improve the efficiency of Web service transactions, such as where only a small amount of data changes between subsequent, similar transactions.

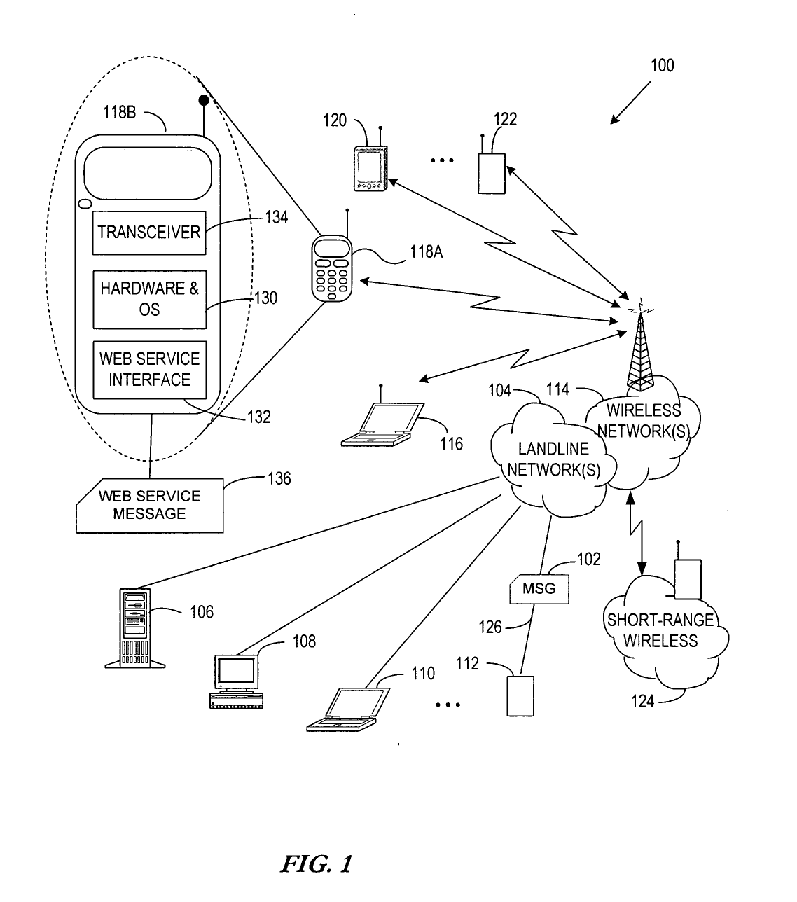

Referring now to FIG. 1, a representative system environment 100 is illustrated in which Web services may be employed according to embodiments of the present invention. In the representative system environment 100, Web services may be communicated using a reduced message 102 between target devices in any number of known manners. These manners include via a landline network(s) 104, which may include a Global Area Network (GAN) such as the Internet, one or more Wide Area Networks (WAN), Local Area Networks (LAN), and the like. Any computing device or other electronic device that supports Web services may be the target system that utilizes the present invention, such as servers 106, desktop computers 108 or workstations, laptop or other portable computers 110, or any other similar computing device capable of communicating via the network 104, as represented by generic device 112.

The Web services may be communicated using some manner of reduced Web service message 102 via one or more wireless networks 114, such as Global System for Mobile Communications (GSM), Universal Mobile Telecommunications System (UMTS), Personal Communications Service (PCS), Time Division Multiple Access (TDMA), Code Division Multiple Access (CDMA), or other mobile network transmission technology. Again, any mobile electronic device can communicate with a reduced Web service message 102, such as laptop or other portable computers 116, mobile phones 118A and other mobile communicators, Personal Digital Assistants (PDA) 120, or any other similar computing device capable of communicating via the wireless network 114, as represented by generic device 122.

The Web service message 102 may be transferred between devices using short-range wireless technologies 124, such as Bluetooth, Wireless Local Area Network (WLAN), infrared (IR), etc. The reduced message 102 can also be distributed using direct wired connections, such as depicted by connection path 126. The present invention is applicable regardless of the manner in which data is provided or distributed between the target devices.

An example of a target device that utilizes Web service messaging is illustrated as the mobile phone 118B. The mobile phone 118B includes, for example, a radio transceiver 134 and hardware (including the processor) coupled to an operating system (OS) 130. A Web services interface 132 may be implemented as firmware or as a program running on the OS 130. The Web services interface may use any combination of Web service protocols known in the art, including SOAP, XML-Remote Procedure Call (XML-RPC), Universal Description, Discovery and Integration (UDDI), and Web Services Description Language (WSDL).

The Web services interface 132 communicates using a reduced Web service message 102 according to embodiments of the present invention. The reduced Web service message 102 may be formed from a standard Web service message 136 that originates on the mobile phone 118B. The standard Web service message 136 may be converted to the reduced message 102 at the mobile phone 118B, or at any other network entity of the system environment 100. Similarly, the reduced message 102 may be converted back to a reproduction of the original Web service message and then received at the mobile phone 118B. The replicated message may be formed at the mobile phone 118B, or at any network entity between the phone 118B and the originator of the message 102.

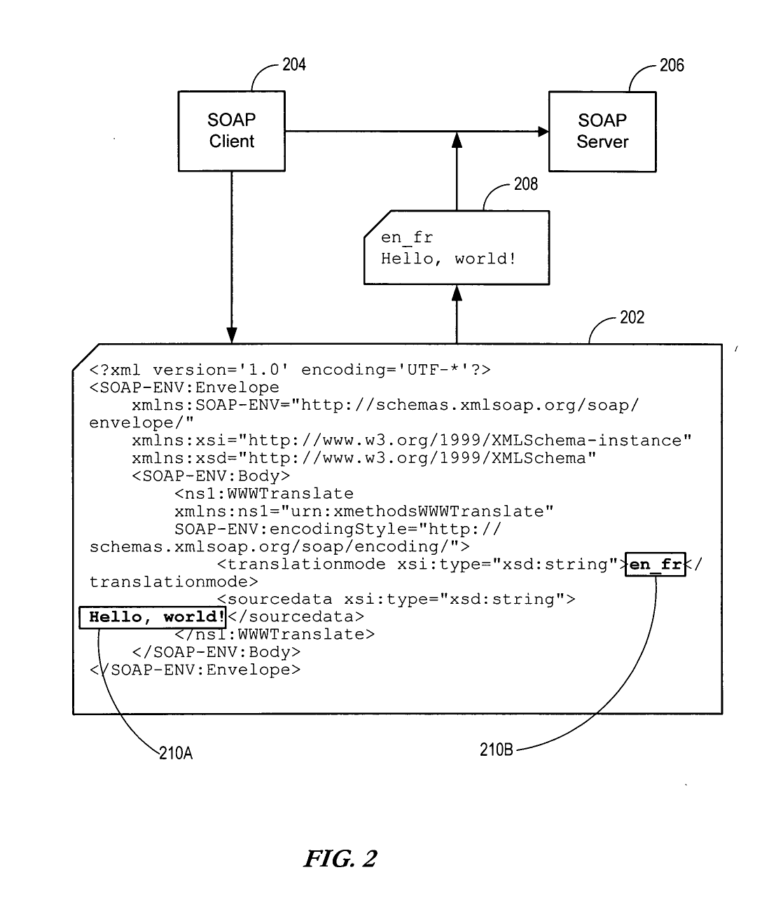

In general, it is desirable to reduce the size of Web service messages to reduce network bandwidth. Other benefits may also be realized provided by reducing Web service messages, such as making the data harder to analyze by unauthorized intermediary nodes that are scanning the data. An example of reducing the size of a Web service message is shown in FIG. 2. The example messages shown in FIG. 2 and other parts of this disclosure are formatted using the Simple Object Access Protocol (SOAP). It will be appreciated by those skilled in the art that the concepts described may be applied to other Web service protocol messages, as well as other data processing applications where message exchanges are used.

In FIG. 2, a SOAP message 202 is created at a source network entity 204 and targeted for a destination entity 206. In this example, the source entity 204 is a SOAP client and the destination entity 206 is a SOAP server. It will be appreciated, however, the these concepts described are applicable to other arrangements, such as messages originating at the SOAP server 206 and destined for the SOAP client 204, or in peer-to-peer, multicast, or broadcast message architectures.

In general, a large part of the data included in a SOAP procedure call includes data that may not vary upon subsequent invocations of the SOAP procedure. This data will be referred to herein as “invariant data.” However, some data may vary upon nearly every invocation of a SOAP procedure, such as parameter values supplied to invoke the method. This data will be referred to herein as “variant data.” At some point along the data connection between the entities 204, 206, the SOAP message 202 is converted to a reduced message 208. The reduced message 208 may contain at least the variant data 210A, 210B of the original message, or some representation of the variant data 210A, 210B.

The example SOAP message 202 is used to invoke a translation of a string 210A from English to French, as indicated by the mode string 210B. This variant data may be particular to the current invocation, and the rest of the data (e.g., the invariant data) will simply be repeated in subsequent invocations of the same SOAP procedure. The invariant data may change over time, such as when a new XML schema is adopted by one or more of the entities. However, this would represent a change to the SOAP procedure interface, and can be dealt with accordingly.

The reduced message 208 shown in FIG. 2 may contain only the variant data, along with delimiters such as tabs or control characters. The reduced message 208 may also contain other delimiters that indicate data structures such as arrays. These structural delimiters may include the original XML tags, or some shortened type of delimiter.

The arrangement of a reduced message 208 with only the variant data may be usable in some applications. This requires the network entity receiving the reduced message 208 assume that data received in a particular way will contain a certain data format. This data format includes the number and type of data items to be transmitted, what encoding is to be used, the order of multiple data items, etc.

Because the reduced message 208 may not conform to any standard Web service formats, the reduced message may be communicated using different mechanisms than standard Web service messages. In one example, the receiving entity 206 may have a particular TCP port in use just for reduced message forms. Other arrangements may utilize special fields in protocol (e.g., HTTP) headers. Whatever transmission/transport mechanism is used, the receiving entity 206 may simply process the reduced message 208 without further changes. In other arrangements the receiving entity may create a reproduction of the original message 202 for use by a standard SOAP parser.

In general, processing the reduced message 208 without further changes may be useful and efficient for some applications. In other applications, it may be useful to convert the reduced message 208 to a reproduction of the original message 202. In this arrangement, a standard SOAP parser on the receiving entity 206 can readily process the reproduction. Creating a reproduction of the original message 202 allows the system to retain the advantages of the SOAP standard. Also, the receiving entity 206 may provide the same functionality using a standard SOAP message interface as well as a reduced message interface. Therefore, by converting the reduced message 208 to a full SOAP message, the core mechanisms that provide Web service processing can be maintained in one module (e.g., the SOAP processing module).

It will be appreciated that the sending and receiving entities 204, 206 require some predetermined criteria for forming the reduced message 208 and reproducing the original message 202 from the reduced message 208. In the illustrated example, a simple method of forming the reduced message 208 would be to parse the SOAP message 202 to extract the “translationmode” and “sourcedata” entries 210B, 210A and place the entries 210B, 210A in the reduced message 208 in a predetermined order.

Forming the reproduction in this example could simply involve storing the invariant data as a text string on the receiving entity 206, inserting the appropriate variant data from the reduced message 208 into the text string to form a reproduction SOAP message. This reproduction SOAP message can be sent to the to the SOAP parser on the receiving entity 206. In this example, the invariant text string used by the receiving entity 206 to form the reproduction message may contain all the text (or some SOAP parsable equivalent) in the message 202, except for 210A and 210B.

The procedure described above is simple, but it may require many assumptions to be made by both entities 204, 206, including the SOAP procedure to be invoked, arrangement of data, and data types of the parameters. This can make it difficult to change or extend functionality of the Web services. However, if a description or other reference to the invariant data can be stored in a location commonly accessible by both entities 204, 206, this allows the invariant data (and thus the SOAP procedure call) to be modified or extended. Commonly accessible invariant data can ensure consistency when reducing and reproducing messages, even when the invariant data changes. If the invariant data is stored in a commonly accessible location, a reference to the data location may be included as part of the reduced message 208. In another arrangement, a reduced representation of the invariant data may be placed in the reduced message 208.

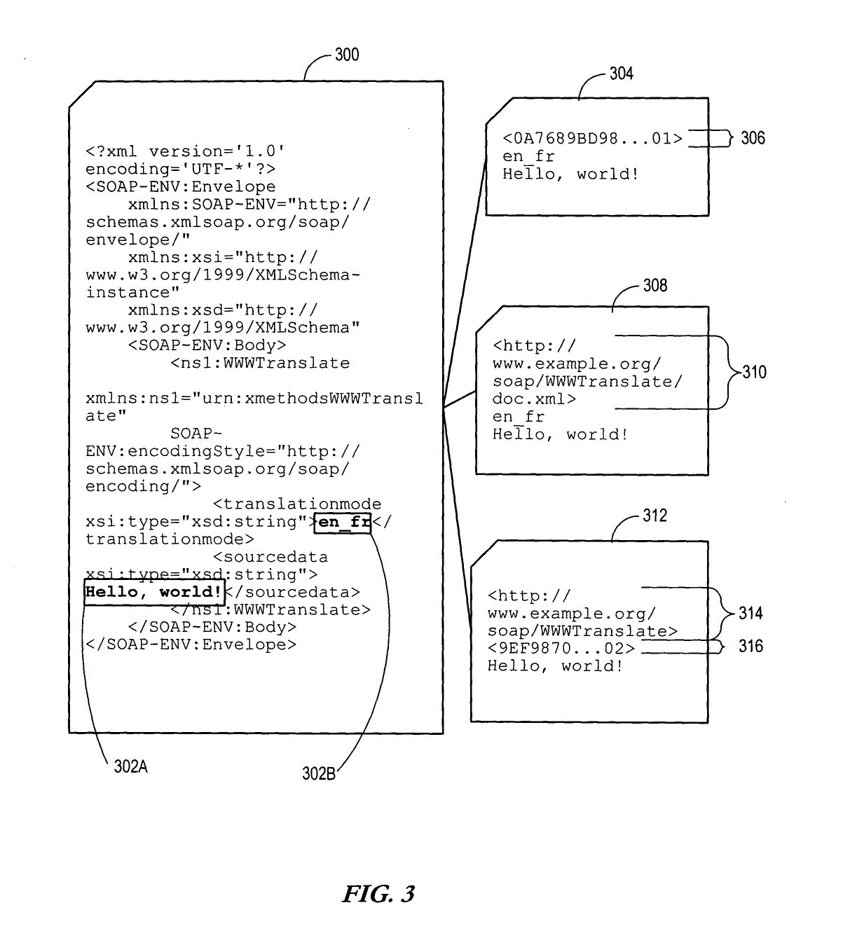

Various examples of producing a reduced message from a SOAP message using additional reference data are illustrated in FIG. 3 according to embodiments of the present invention. The additional reference data may be included in the message body, or in various message headers (e.g., HTTP headers). FIG. 3 shows a full SOAP message 300 that is similar to message 202 in FIG. 2, and includes variant portions 302A and 302B.

In one example, a reduced message 304 is formed from the SOAP message 300 by including a binary portion 306 with the message 304. The binary portion 306 may be used to represent part or all of the invariant data of the original message 300. The binary portion 306 may be a compressed representation of the invariant data, or may be an interface identifier such that it references a particular SOAP procedure that is known beforehand by message senders and receivers. In the latter case, the binary portion 306 may be an interface identifier formed using predetermined number assignment, such as a database identifier. In another example, the interface identifier may be formed using algorithms for generating unique identifiers, such as the algorithm used to generate UUIDs. In another arrangement, the binary portion 306 may be the result of a hash algorithm performed on the invariant data.

An alternate method of reducing message size is represented by the reduced message 308. In message 308, a Uniform Resource Identifier (URI) 310 references a Web accessible location where a description of the invariant data may be found. The URI 310, and other references such as Uniform Resource Locators (URL), can be used to describe a unique location from which data can be retrieved. The URI 310 may include a different location for different target SOAP procedures, each location thereby uniquely identifying the SOAP procedure invoked by the message 308, as well as other criteria for dealing with reduced messages. Different URIs 310 may also be used where variations are allowed for the same target SOAP procedure, such as when optional parameters or different type parameters may be submitted.

The doc.xml referenced in the example URI 310 can be an XML language document that describes the criteria used in reducing and replicating SOAP messages. The document may be any format, such as the Web Services Description Language (WSDL). Of course, the URI 310 may reference any manner of Web accessible object besides XML files, including text documents or binary content of any type, including programs. In general, the URI 310 can be used to define the guidelines for forming the reduced message 308 from the original message 300, and for forming a replicated message from the reduced message 308.

A third reduced message 312 is also shown in FIG. 3. This message 312 contains both a URI 314 and a binary portion 316. The URI 314 can be used as previously described in providing a reference to the message reduction/replication criteria. The binary portion 316 can be combined with the URI 314 (e.g., an argument to a CGI script), or may be formed independently of the URI 314. The binary portion 316 may be a compressed form of some part of the variant or invariant message data. Although the binary portions 306, 316 are shown as hexadecimal numbers using ACSII characters, it will be appreciated that the data can be represented using any technique known in the art, including true binary (if supported by the underlying protocols), or encoded using a technique such as Network Data Representation (NDR) or Base-64.

Many variations of forming reduced messages using included representation data are possible besides those described in relation to FIG. 3. For example, text fragments from invariant parts of the original message 300 may be included in a reduced message. In another example, two connected devices may perform a negotiation of reduced message schemes to use. The devices could perform a handshaking to agree any combination of reduced messaging schemes. The devices could also initiate reduced messaging by first invoking a SOAP method using standard SOAP messages, and embed data in the initial SOAP messages that describe a reduced message format to be used on subsequent invocations of the SOAP method.

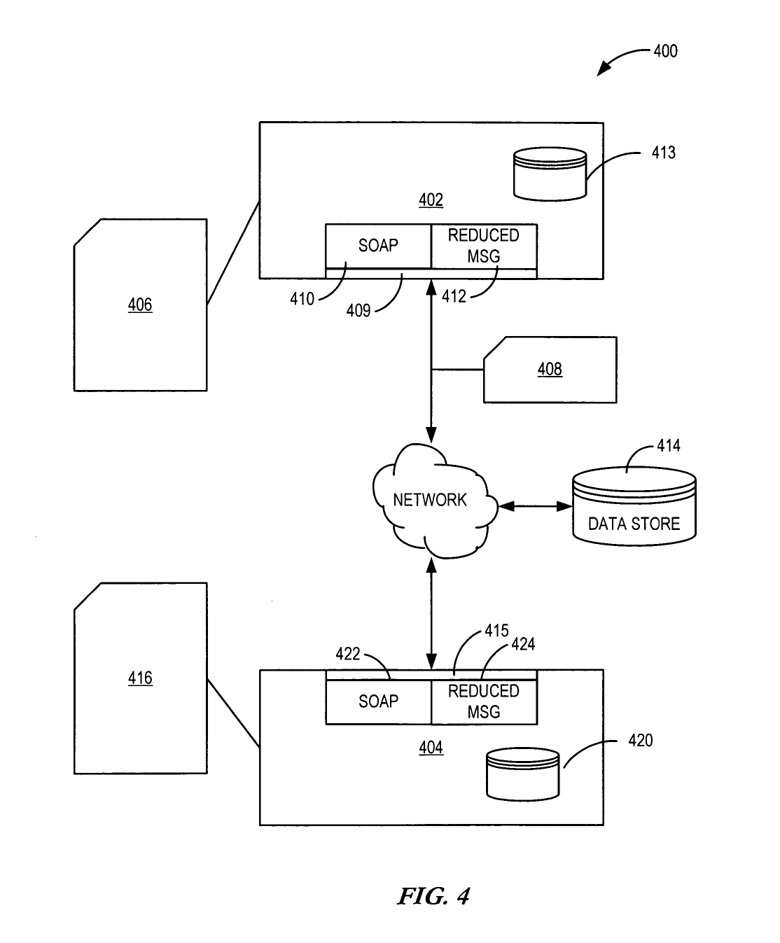

Reduced messaging can be used between any two connected network entities. Various arrangements of the network entities may be useful in different scenarios. The diagram 400 of FIG. 4 illustrates a system 400 of network entities arranged to exchange reduced SOAP messages according to embodiments of the present invention. A message 406 originates at a source entity 402 and is targeted for the destination entity 404. In the illustrated arrangement, the source entity 402 translates the message 406 to a reduced message 408 before sending data over a network interface 409. The translation may occur within a SOAP processing module 410 or may occur in a separate messaging module 412 that can interface with the SOAP module 410.

The source entity 402 may utilize criteria that are stored in a local data store 413 for creating the reduced message 408. The criteria may also be extracted from a commonly accessible external data store 414. Systems may use one or both of an internal store 413 and a commonly accessible external data store 414 when dealing with reduced messages. In one example, the criteria from the external data store 414 can be cached in the local data store 413 to minimize network bandwidth when accessing relatively static criteria data.

The reduced message 408 is received by the destination entity 404 at a network interface 415. The destination entity 404 may process the reduced message as is, or the entity 404 may use the reduced message 408 to form a reproduction message 416. The reproduction message 416 need not be identical to the original message 406, although in general the result of the invoked SOAP procedure should be the same using either the original message 406 or the reproduction message 416. The destination entity 404 may utilize common criteria for creating the reproduction 416 from the reduced message 408. As with the source entity 402, the common criteria may be stored in any combination of an internal data store 420 or an external data store 414. The reproduction message 416 may be formed either at a SOAP processing module 422 or separate reduced message module 424 of the destination entity 404.

It will be appreciated by those skilled in the art that the operations involved in sending messages between the source entity 402 and the destination entity 404 may be adapted for messages sent in the opposite direction. SOAP procedure calls are typically followed by the sending of responses, and these responses can be SOAP messages. In other cases, a SOAP response message may be the result of a non-SOAP request, which may or may not utilize a reduced messaging arrangement. Therefore, using a reduced message 408 in responses from destination entity 404 to source entity 402 can provide the benefits of the reduced message 408 for a variety of transactions.

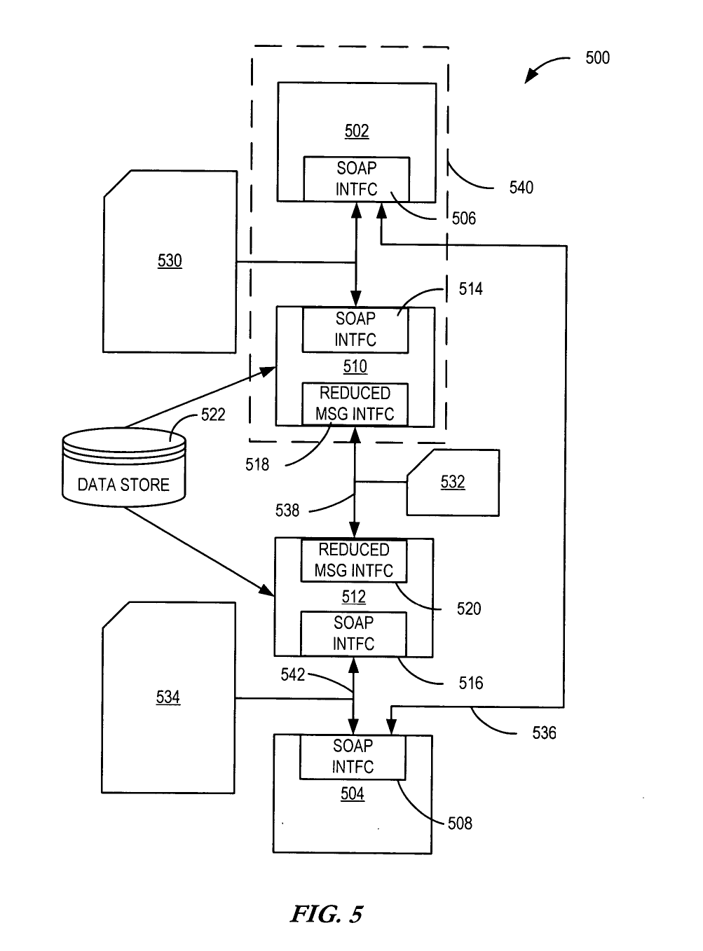

Although using direct host-to-host reduced messaging is useful, it may be desirable to provide this functionality without modifying existing SOAP clients and servers. In one example, reduced messaging capabilities can be provided for legacy systems by using intermediary entities. Referring now to FIG. 5, an alternate system 500 of providing Web services is illustrated according to embodiments of the present invention. In this system 500, a source entity 502 and a destination entity 504 may include standard SOAP interfaces, 506 and 508, respectively. The source and destination entities 502, 504 can utilize existing SOAP software modules, programming tools, and procedure calls. One or more intermediate entities, as represented by intermediate nodes 510 and 512, may act as proxies or gateways for SOAP communications using reduced messaging. The intermediate nodes 510, 512, typically include SOAP interfaces, 514, 516, respectively for communicating with the source and destination entities 502, 504. The SOAP interfaces 514, 516 allow the operation of Web services using reduced messages to be transparent to end nodes such as entities 502, 504.

A SOAP message 530 sent from the source entity 502 may be received at the SOAP interface 514 of intermediate node 510. The intermediate node 510 can create a reduced message 532 from pre-arranged set of rules, an internal cache, or from some criteria accessible at a common data store 522. The reduced message 532 is sent from a reduced message interface 518 of intermediate node 510 to a reduced message interface 520 of intermediate node 512. Intermediate node 512 uses a compatible set of criteria (e.g., from the data store 522) to form a reproduced message 534 from the reduced message 532. The reproduced message 534 is sent from the SOAP interface 516 to the SOAP interface 508 of the destination node 504. Of course, sending messages in the other direction from entity 504 to entity 502 operates similarly, with the intermediate nodes 510, 512 forming reduced messages or reproduced messages as appropriate.

In general, the system 500 shown in FIG. 5 allows a legacy SOAP infrastructure to benefit from the use of reduced messages. Of course, the system 500 may allow standard SOAP message exchanges between source and destination entities 502, 504, as represented by the path 536. The intermediate nodes 510, 512 may also be configured to handle some portion of standard SOAP messaging (e.g., without forming reduced messages) between endpoints 502, 504. In some arrangements, a predetermined set of messages may be targeted reduced message processing at intermediary nodes 510, 512, while other messages take the direct path 536 between entities 502, 504.

The use of intermediary nodes 510, 512 is useful when a data path 538 between the gateway nodes 510, 512 is a low-bandwidth connection. A more typical situation, however, is where the low-bandwidth connection is the network entry point of an end user, such as a mobile data client. This endpoint is represented in FIG. 5 as a unit 540 that encompasses both the network entity 502 and the intermediate node 510. For example, if the unit 540 represents a mobile device, the intermediate node 510 could be implemented as a processing module within the mobile device. Such a processing module may be an extension of the SOAP protocol stack, or may be implemented as a separate process that interfaces with the stack. In such an arrangement, the reduced message interface 518 of the unit 540 communicates with the intermediate node 512. The intermediate node 512 may be located anywhere on the network, preferably where the connection 542 between the intermediate node 512 and destination entity 504 includes a high bandwidth connection.

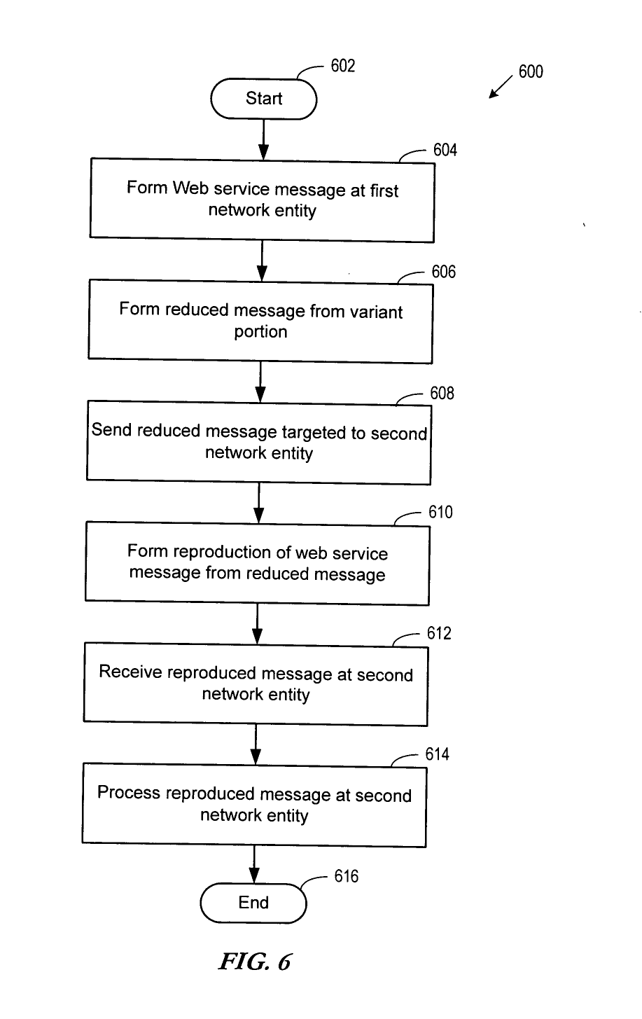

The flowchart 600 of FIG. 6 illustrates an example procedure of performing Web service communications using reduced messages according to embodiments of the present invention. At the start (602) of the procedure, a first network entity forms (604) a Web service message. A reduced message is then formed (606) using at least the variant part of the Web service message. The reduced message is sent (608) across a network or other communication means and targeted for a second data processing entity. A reproduction of the original message is formed (610) using the reduced message. The reproduced message is received (612) at the second network entity. This second entity can then process (614) this reproduced Web service message as usual, after which the routine is complete (616).

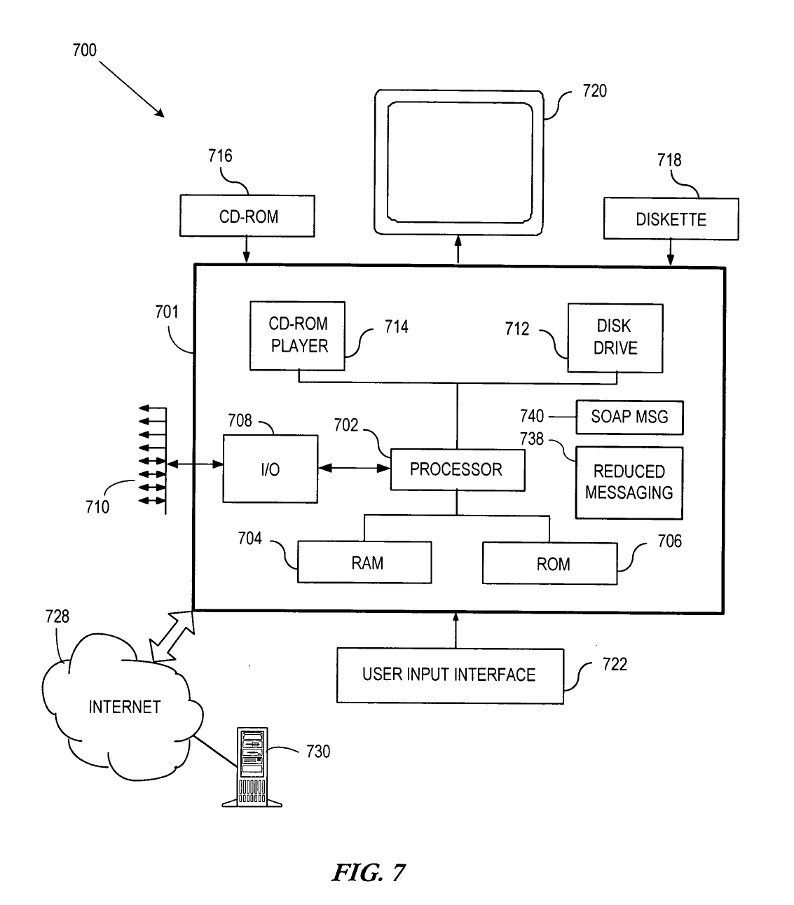

The network clients, servers or other systems for providing Web service messaging functions in connection with the present invention may be any type of computing device capable of processing and communicating digital information. The messaging systems utilize computing systems to control and manage the messaging activity. An example of a representative computing system capable of carrying out operations in accordance with embodiments of the present invention is illustrated in FIG. 7. Hardware, firmware, software or a combination thereof may be used to perform the various messaging functions and operations described herein. The computing structure 700 of FIG. 7 is an example computing structure that can be used in connection with such a Web services messaging system.

The example computing structure 700 suitable for performing the messaging activity in accordance with the present invention includes a computing arrangement 701. The computing arrangement 701 may act a server, client, gateway, proxy, or any other network entity used for processing and delivering Web service messages. The computing arrangement 701 includes a central processor (CPU) 702 coupled to random access memory (RAM) 704 and read-only memory (ROM) 706. The ROM 706 may also be other types of storage media to store programs, such as programmable ROM (PROM), erasable PROM (EPROM), etc. The processor 702 may communicate with other internal and external components through input/output (I/O) circuitry 708 and bussing 710, to provide control signals and the like. For example, processing of SOAP messages and reduced messages, such as those exemplified in FIG. 3, may be performed by the computing arrangement 701 at a reduced message processing module 738. The reduced message module 738 can communicate using SOAP messages with a SOAP messaging module 740.

External data storage devices, such as databases, used for accessing message reduction criteria, may be coupled to I/O circuitry 708 to facilitate messaging functions according to the present invention. Alternatively, such databases may be locally stored in the storage/memory of the server 701, or otherwise accessible via a local network or networks having a more extensive reach such as the Internet 728. The processor 702 carries out a variety of functions as is known in the art, as dictated by software and/or firmware instructions.

The computing arrangement 701 may also include one or more data storage devices, including hard and floppy disk drives 712, CD-ROM drives 714, and other hardware capable of reading and/or storing information such as DVD, etc. In one embodiment, software for carrying out the messaging operations in accordance with the present invention may be stored and distributed on a CD-ROM 716, diskette 718 or other form of media capable of portably storing information. These storage media may be inserted into, and read by, devices such as the CD-ROM drive 714, the disk drive 712, etc. The software may also be transmitted to computing arrangement 701 via data signals, such as being downloaded electronically via a network, such as the Internet 728. The computing arrangement 701 may be coupled to a display 720, which may be any type of known display or presentation screen, such as LCD displays, plasma display, cathode ray tubes (CRT), etc. A user-input interface 722 may be provided, including one or more user interface mechanisms such as a mouse, keyboard, microphone, touch pad, touch screen, voice-recognition system, etc.

The computing arrangement 701 may be coupled to other computing devices, such as landline and/or wireless terminals via a network, for Web service messaging. The server may be part of a larger network configuration as in a global area network (GAN) such as the Internet 728, which allows connections to the various landline and/or mobile devices.

The use of reduced messages in Web services may be of advantage when included in mobile devices. The mobile devices may be any type of wireless device, such as wireless/cellular telephones, personal digital assistants (PDAs), or other wireless handsets, as well as portable computing devices capable of wireless communication. These landline and mobile devices utilize computing circuitry and software to control and manage the conventional device activity as well as the message functionality as described herein. Hardware, firmware, software or a combination thereof may be used to perform the various Web service messaging functions described herein.

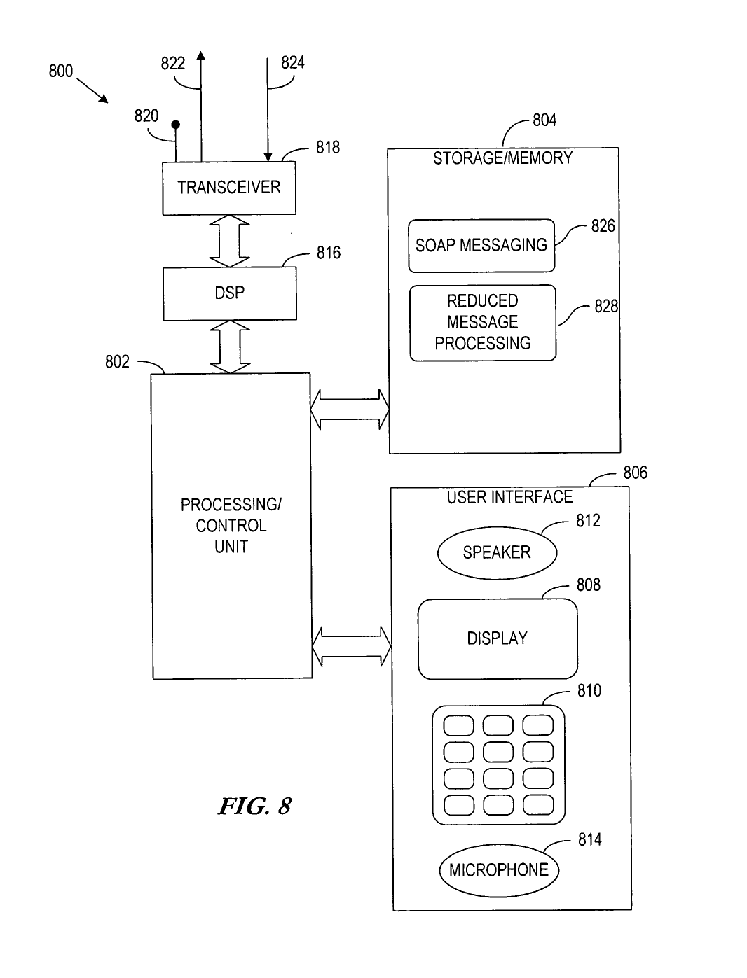

An example of a representative mobile terminal computing system capable of carrying out operations in accordance with the invention is illustrated in FIG. 8. Those skilled in the art will appreciate that the exemplary mobile computing environment 800 is merely representative of general functions that may be associated with such mobile devices, and also that landline computing systems similarly include computing circuitry to perform such operations.

The mobile computing arrangement 800 is suitable for facilitating Web service communications using reduced messages in accordance with embodiments of the present invention. The representative mobile computing arrangement 800 includes a processing/control unit 802, such as a microprocessor, reduced instruction set computer (RISC), or other central processing module. The processing unit 802 need not be a single device, and may include one or more processors. For example, the processing unit may include a master processor and associated slave processors coupled to communicate with the master processor.

The processing unit 802 controls the basic functions of the mobile terminal, and also those functions associated with the present invention as dictated by the SOAP messaging module 826 and reduced message processor 828 available in the program storage/memory 804. Thus, the processing unit 802 may be capable of sending and receiving messages using the SOAP messaging module 826 and/or the reduced message processor 828. The reduced message processor 828 may be arranged to translate messages and communicate these messages with the SOAP messaging module 826.

The program storage/memory 804 may also include an operating system and program modules for carrying out functions and applications on the mobile terminal. For example, the program storage may include one or more of read-only memory (ROM), flash ROM, programmable and/or erasable ROM, random access memory (RAM), subscriber interface module (SIM), wireless interface module (WIM), smart card, or other removable memory device, etc.

In one embodiment of the invention, the program modules associated with the storage/memory 804 are stored in non-volatile electrically-erasable, programmable ROM (EEPROM), flash ROM, etc. so that the information is not lost upon power down of the mobile terminal. The relevant software for carrying out conventional mobile terminal operations and operations in accordance with the present invention may also be transmitted to the mobile computing arrangement 800 via data signals, such as being downloaded electronically via one or more networks, such as the Internet and an intermediate wireless network(s).

The processor 802 is also coupled to user-interface 806 elements associated with the mobile terminal. The user-interface 806 of the mobile terminal may include, for example, a display 808 such as a liquid crystal display, a keypad 810, speaker 812, and microphone 814. These and other user-interface components are coupled to the processor 802 as is known in the art. Other user-interface mechanisms may be employed, such as voice commands, switches, touch pad/screen, graphical user interface using a pointing device, trackball, joystick, or any other user interface mechanism.

The mobile computing arrangement 800 also includes conventional circuitry for performing wireless transmissions. A digital signal processor (DSP) 816 may be employed to perform a variety of functions, including analog-to-digital (A/D) conversion, digital-to-analog (D/A) conversion, speech coding/decoding, encryption/decryption, error detection and correction, bit stream translation, filtering, etc. The transceiver 818, generally coupled to an antenna 820, transmits the outgoing radio signals 822 and receives the incoming radio signals 824 associated with the wireless device.

The mobile computing arrangement 800 of FIG. 8 is provided as a representative example of a computing environment in which the principles of the present invention may be applied. From the description provided herein, those skilled in the art will appreciate that the present invention is equally applicable in a variety of other currently known and future mobile and landline computing environments. For example, desktop computing devices similarly include a processor, memory, a user interface, and data communication circuitry. Thus, the present invention is applicable in any known computing structure where data may be communicated via a network.

Using the description provided herein, the invention may be implemented as a machine, process, or article of manufacture by using standard programming and/or engineering techniques to produce programming software, firmware, hardware or any combination thereof. Any resulting program(s), having computer-readable program code, may be embodied on one or more computer-usable media, such as disks, optical disks, removable memory devices, semiconductor memories such as RAM, ROM, PROMS, etc.

Articles of manufacture encompassing code to carry out functions associated with the present invention are intended to encompass a computer program that exists permanently or temporarily on any computer-usable medium or in any transmitting medium which transmits such a program. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links. From the description provided herein, those skilled in the art will be readily able to combine software created as described with appropriate general purpose or special purpose computer hardware to create a messaging system, apparatus, and method in accordance with the present invention.

The foregoing description of the various embodiments of the invention has been presented for the purposes of illustration and description. It is not intended to be exhaustive or to limit the invention to the precise form disclosed. Many modifications and variations are possible in light of the above teaching. Thus, it is intended that the scope of the invention be limited not with this detailed description, but rather determined from the claims appended hereto.

1. A method comprising:
forming a reduced message at a first network entity based on at least a variant portion of a Web service message, the Web service message including a data set targeted for processing on a second network entity;
sending the reduced message targeted for the second network entity via a network; and
processing the data set at the second network entity based on the reduced message.

2. The method according to claim 1, wherein the Web service message comprises a SOAP message.

3. The method according to claim 1, wherein forming the reduced message comprises forming reference data based on an invariant portion of the Web service message and including the reference data in the reduced message.

4. The method according to claim 3, wherein the reference data comprises a binary representation of the invariant portion.

5. The method according to claim 3, wherein the reference data comprises a reference to a data store containing criteria for creating a reproduction of the invariant portion.

6. The method according to claim 5, wherein the reference to the data store comprises a Universal Resource Identifier (URI).

7. The method according to claim 1, wherein processing the data set at the second network entity based on the reduced message comprises:
forming a reproduction of the Web service message based on the reduced message; and
processing the reproduction of the Web service message at the second network entity.

8. The method according to claim 7, wherein forming the reduced message comprises forming reference data based on an invariant portion of the Web service message and including the reference data in the reduced message.

9. The method according to claim 8, wherein forming the reproduction of the Web service message comprises forming the reproduction of the Web service message from a reproduction of the invariant portion of the Web service message.

10. The method according to claim 7, wherein the reference data comprises a binary representation of the invariant portion.

11. The method according to claim 7, wherein the reference data comprises a reference to a data store containing criteria for creating a reproduction of the invariant portion.

12. The method according to claim 11, wherein the reference to the data store comprises a Universal Resource Identifier (URI).

13. A messaging system, comprising:
a first data processing arrangement coupled to transmit a reduced message based on at least a variant portion of a Web service message, the Web service message defining a set of data targeted for processing on a data processing arrangement;
a message processing arrangement coupled to receive the reduced message and transmit a reproduction of the Web service message based on the reduced message; and
a second data processing arrangement coupled to receive the reproduction of the Web service message and process the set of data based on the reproduction of the Web service message.

14. The messaging system according to claim 13, wherein the Web service message includes a SOAP message.

15. The messaging system according to claim 13, wherein the message processing arrangement includes a third data processing arrangement coupled to the first and second data processing arrangements via a network.

16. The messaging system according to claim 13, wherein the message processing arrangement includes a message processing module operable on the second data processing arrangement.

17. A messaging system, comprising:
first data processing means for transmitting a Web service message, the Web service message including a variant portion and a data set targeted for processing at one or more data processing means;
message processing means for receiving the Web service message and transmitting a reduced message based on at least the variant portion of the Web service message;
second data processing means for receiving the reduced message and processing the data set of the Web service message based on the reduced message.

18. The messaging system according to claim 17, wherein the Web service message includes a SOAP message.

19. The messaging system according to claim 17, wherein the second data processing means is further configured for forming a reproduction of the Web service message based on the reduced message and transmitting the reproduction of the Web service message, the messaging system further comprising third data processing means for receiving the reproduction of the Web service message and processing the data set of the Web service message based on the reproduction of the Web service message.

20. The messaging system according to claim 17, further comprising means for storing a criteria accessible by the message processing means, the criteria used by the message processing means for forming the reduced message based at least on the variant portion of the Web service message.

21. A mobile terminal wirelessly coupled to a network which includes a network element, the mobile terminal comprising:
a memory capable of storing at least one of a messaging module and a Web services processing module;
a processor coupled to the memory and configured by the messaging module to form outgoing reduced messages targeted for the network element based on at least variant portions of Web service messages generated at the Web services processing module, the processor further configured by the messaging module to form reproduced Web service messages targeted for the Web services processing module based on incoming reduced messages from the network element; and
a transceiver configured to facilitate exchange of the incoming and outgoing reduced messages with the network element.

22. The mobile terminal according to claim 21, wherein the Web service messages include SOAP messages.

23. A computer-readable medium having instructions stored thereon which are executable by a mobile terminal for exchanging messages with a remote data processing arrangement coupled via a network by performing steps comprising:
forming a reduced message based on at least a variant portion of a Web service message, the Web service message including a data set targeted for processing on the remote data processing arrangement;
sending the reduced message targeted for the remote data processing arrangement; and
receiving a response message from the remote data processing arrangement in response to the reduced message.

24. The computer readable medium according to claim 23, wherein the response message comprises a reduced response message based on at least a variant portion of a Web service response message generated by the remote data processing arrangement.

25. The computer readable medium according to claim 24, wherein the steps further comprise:
forming a reproduction of the Web service response message based on the reduced response message; and
processing the reproduction of the Web service response message.

26. The computer readable medium according to claim 23, wherein the Web service message comprises a SOAP message.

27. A server within a network used to facilitate an exchange of messages, comprising:
means for receiving a reduced message based on at least a variant portion of a Web service message originating from a first terminal and targeted for a second terminal;
means for forming a reproduction of the Web service message based on the reduced message; and
means for sending the reproduction of the Web service message to the second terminal.

28. The server according to claim 27, further comprising means for accessing a data store containing criteria for forming the reproduction of the Web service message based on the reduced message.

29. The server according to claim 27, wherein the Web service message comprises a SOAP message.
